(19) United States
(12) Patent Application Publication
(10) Pub. No.: US 2024/0359575 A1
(43) Pub. Date: Oct. 31, 2024

(54) TANDEM ELECTRIC VEHICLE CHARGING

(71) Applicant: GM GLOBAL TECHNOLOGY OPERATIONS LLC, Detroit, MI (US)

(72) Inventors: Mohamed A. Naiel, Ajax (CA); Abdulrahman Al-Shanoon, Toronto (CA); Michael D. Alarcon, Markhan (CA); Yun Qian Miao, Waterloo (CA); James C. Gibbs, Brighton, MI (US); Aniket P. Kothari, Rochester Hills, MI (US); Brian A. Welchko, Oakland Township, MI (US)

(73) Assignee: GM GLOBAL TECHNOLOGY OPERATIONS LLC, Detroit, MI (US)

(21) Appl. No.: 18/307,218

(22) Filed: Apr. 26, 2023

(51) Int. Cl. B60L 53/18; G06Q 50/06; H02J 7/00; H02J 7/34

(52) U.S. Cl. CPC B60L 53/18; G06Q 50/06; H02J 7/007; H02J 7/0071; H02J 7/342; G06V 20/625

(57) ABSTRACT

Tandem charging for electric vehicles (EVs) electrically interconnected with each other. The tandem charging may include determining a plurality of EVs requesting to be charged with electrical power available from a charging station, determining charging parameters for the EVs, scheduling charging of the EVs according to the charging parameters, and/or authorizing a pecuniary charge to billing accounts of the EVs in recompense for the charging.

### INTRODUCTION

The present disclosure relates to electric vehicle (EV) charging, such as but not necessarily limited to tandem EV charging of the type whereby electrical power for charging may be transferred from one EV to another EV.

A charging station for charging EVs may include a charging cable configured for distributing electric power. The charging cable may be configured for connecting to one EV at a time. The limitation of connecting to one EV at a time can be problematic when multiple EVs desire access to the charging station. In the event a charging station includes additional charging cables or multiple access points, it may still be problematic for multiple EVs to access the charging station, particularly when other EVs may be parked in areas around the charging station and/or when other EVs remain connected to and/or parked near the charging station after completing their charging.

### SUMMARY

One non-limiting aspect of the present disclosure relates to an electric vehicle (EV) charging system and method for tandem charging of the type whereby two or more EVs may be electrically interconnected to support charging from a common charging station. The EVs may be electrically connected in series and/or parallel with each other and correspondingly controlled for distributing electrical power from the charging station and/or from another EV to one or more additional EVs interconnected therewith. The EVs may include a switch controller configured for selectively bypassing electrical power to one or more downstream connected EVs such that electrical power may be bypassed or otherwise relayed thereafter from one EV to another, optionally with the source of electrical power being a charging station and/or another one of the EV.

One non-limiting aspect of the present disclosure relates to a method for tandem electric vehicle (EV) charging. The method may include determining a primary EV electrically connected to a charging station via a vehicle-to-station (V2S) connection. The charging station may be configured for charging the primary EV with electrical power provided from an electrical grid. The method may further include determining a secondary EV connected to the primary EV via a vehicle-to-vehicle (V2V) connection. The secondary EV may be requesting to be charged with electrical power transferred from the primary EV via the V2V connection. The method may further include determining a secondary EV billing account associated with an operator of the second EV and authorizing a pecuniary charge to the secondary EV billing account in recompense for a secondary transference of electrical power to the secondary EV via the V2V connection.

The method may include determining the pecuniary charge based at least in part on a station amount of electrical power included as at least part of the secondary transference. The station amount may correspond with electrical power provided from the charging station for the secondary transference.

The method may include determining the pecuniary charge based at least in part on a vehicle amount of electrical power included as at least part of the secondary transference. The vehicle amount may correspond with electrical power provided from a battery of the primary EV for the secondary transference.

The method may include determining the pecuniary charge based at least in part on a connection fee for the V2V connection.

The method may include instructing the primary EV to perform a bypass operation as part of the secondary transference. The bypass operation may include bypassing electrical power received at the primary EV via the V2S connection to the secondary EV via the V2V connection.

The method may include instructing the primary EV as part of the bypass operation to control a charging switch from a battery position to a bypass position. The battery position may include directing electrical power received via the V2S connection to a battery of the primary EV. The bypass position may include directing electrical power received via the V2S connection to the V2V connection.

The method may include performing a scheduling process to schedule the secondary transference based on a parking time, a charging speed, and a charging level determined for each of the primary and secondary EVs.

The method may include the scheduling process scheduling the secondary transference to occur after the charging level of the primary EV has been met via a primary transference of electrical power from the charging station to the primary EV via the V2S connection.

The method may include determining a tertiary EV connected to the secondary EV via another V2V connection and the scheduling process scheduling a sequential charging of the EVs according to the charging parameters. The sequential charging may correspond with electrical power originating from the charging station being used to selectively charge no more than one of the EVs at the same time, beginning with the primary EV and ending with the tertiary EV.

The method may include processing an image captured for the secondary EV to determine a license plate attached to the secondary EV, processing the license plate to determine an identifier associated with the operator of the secondary EV, and determining the secondary EV billing account based on the identifier.

One non-limiting aspect of the present disclosure relates to a method for tandem electric vehicle (EV) charging. The method may include determining a plurality of EVs requesting to be charged with electrical power available from a charging station. The plurality of EVs may be a primary EV electrically connected to the charging station via a vehicle-to-station (V2S) connection and requesting to be charged with electrical power transferred from the charging station via the V2S connection, a secondary EV connected to the primary EV via a primary vehicle-to-vehicle (V2V) connection and requesting to be charged with electrical power from the primary EV via the primary V2V connection, and a tertiary EV connected to the secondary EV via a secondary vehicle-to-vehicle (V2V) connection and requesting to be charged with electrical power transferred from the secondary EV via the secondary V2V connection. The method may include determining charging parameters for the EVs and scheduling a sequential charging of the EVs according to the charging parameters. The sequential charging may correspond with electrical power originating from the charging station being used to selectively charge no more than one of the EVs at the same time.

The method may include controlling a charging switch onboard each of the EVs to a bypass position when another EV downstream thereof is scheduled for charging. The bypass position may include bypassing electrical power originating from the charging station to a downstream connected one of the EVs.

The method may include the charging parameters including a parking time, a charging rate, and a charging level. The parking time may represent a time the corresponding EV is scheduled to be connected to another one of the EVs. The charging rate may represent amperes or kilowatt rate available for charging the corresponding EV. The charging level may represent a desired amount of battery charge for the corresponding EV.

The method may include authorizing a pecuniary charge to operators associated with each of the EVs in recompense for the electrical power consumed in the charging thereof.

The method may include identifying the operators associated with each of the EVs according to an image recognition process performed on a license plate image captured therefrom.

One non-limiting aspect of the present disclosure relates to a controller for tandem electric vehicle (EV) charging. The controller may be configured for determining a plurality of EVs requesting to be charged with electrical power available from a charging station, determining charging parameters for the EVs, and scheduling a sequential charging of the EVs according to the charging parameters. The sequential charging may correspond with electrical power originating from the charging station being bypassed from EV to EV with no more than one of the EVs charging at the same time.

The controller may be configured for authorizing a pecuniary charge to operators associated with each of the EVs in recompense for the electrical power consumed in the charging thereof.

The controller may be configured for identifying the operators associated with each of the EVs according to an image recognition process performed on a license plate image captured therefrom.

The controller may be configured for controlling a charging switch onboard each of the EVs to a bypass position when another EV downstream thereof is scheduled for charging. The bypass position may include bypassing electrical power originating from the charging station to a downstream connected to one of the EVs.

The controller may be configured for controlling the charging switch onboard each of the EVs to a battery position when scheduled for charging. The battery position may include directing electrical power originating from the charging station to a battery of the corresponding EV

These features and advantages, along with other features and advantages of the present teachings, are readily apparent from the following detailed description of the modes for carrying out the present teachings when taken in connection with the accompanying drawings. It should be understood that even though the following figures and embodiments may be separately described, single features thereof may be combined to additional embodiments.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates a system for tandem electric vehicle (EV) charging in accordance with one non-limiting aspect of the present disclosure.

FIG. 2 illustrates a schematic diagram of the system in accordance with one non-limiting aspect of the present disclosure.

FIG. 3 illustrates a flowchart of a method for tandem EV charging in accordance with one non-limiting aspect of the present disclosure the method.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

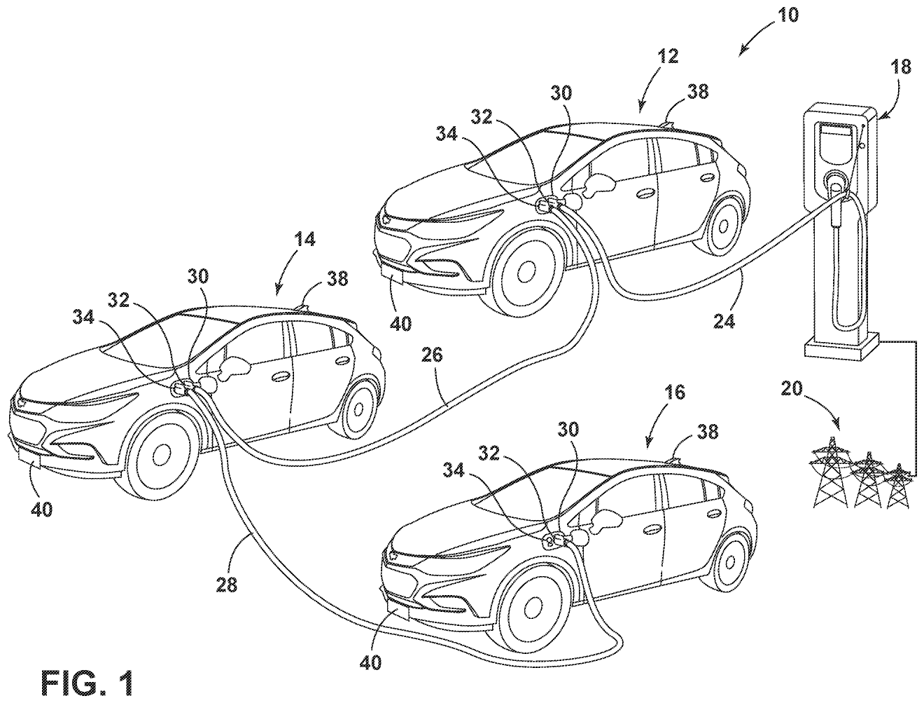

FIG. 1 illustrates a system 10 for tandem electric vehicle (EV) charging in accordance with one non-limiting aspect of the present disclosure. The system 10 is predominately described with respect to charging a plurality of EVs 12, 14, 16 for exemplary purposes as the present disclosure fully contemplates the system 10 being beneficial in facilitating charging of other types of vehicles, devices, equipment, etc. The charging of the EVs 12, 14, 16, however, is predominantly described to highlight the improvements of the present disclosure in enabling EV charging when access to a charging station 18 may be unavailable to multiple EVs 12, 14, 16, such as in the event another EV 12 is connected to the charging station 18, another vehicle or device is parked next to the charging station 18 or otherwise positioned to obstruct access to the charging station 18, etc. The charging station 18 may be configured for providing electric power to and/or receiving electrical power from an electric utility grid 20, which may be included as part of a home electrical system, an access point to a larger electrical grid, a connection to a renewable energy storage system, or other electrical power source. The charging station 18 is shown to be configured as a pedestal-type of charging station, however, the charging station 18 may include other configurations, including a wall-type of charging station, a smart charging station, etc.

The system 10 may be configured for tandem charging a large quantity of EVs 12, 14, 16, assuming the electrical grid 20, the charging station 18, and/or the EVs 12, 14, 16 are capable of supplying electrical power without becoming overloaded. The system 10 is illustrated for non-limiting purposes with respect to tandem charging of three EVs 12, 14, 16, however, a greater number of EVs 12, 14, 16 may be similarly charged. The EVs 12, 14, 16 are shown to be connected serially, with a primary EV 12 being electrically connected to the charging station 18, a secondary EV 14 being electrically connected with the primary EV 12, and a tertiary EV 16 being electrically connected with the secondary EV 14. The EVs 12, 14, 16 may be connected in other configurations, such as with two or more the EVs 12, 14, 16 being connected in parallel. The EVs 12, 14, 16 may be interconnected with each other in the illustrated manner via a plurality of charging cables 24, 26, 28 and/or through other mechanisms or configurations sufficient for electrical power exchange, e.g., charging pads, wireless or inductive charging systems, etc. To be inclusive of the wide variety of mechanisms available for electrically interconnecting the EVs 12, 14, 16, and without limitation, the connection between the primary EV and the charging station 18 may be referred to as a vehicle-to-station (V2S) connection and the connections between the primary and secondary EVs 12, 14, 16 and the secondary and tertiary EVs 12, 14, 16 may be referred to as vehicle-to-vehicle (V2V) connections.

The EVs 12, 14, 16 may include a charging receptacle 30 configured for establishing removable electrical connections with the charging cables 24, 26, 28. The charging receptacles 30 may be configured with multiple interfaces, such in the illustrated dual-interface configuration, whereby one interface may be configured as an input interface 32 for receiving electrical power and another interface may be configured as an output interface 34 for transmitting electrical power. The dual-interface configuration is shown for non-limiting purposes as the present disclosure fully contemplates the charging receptacles 30 including additional interfaces and/or other mechanisms for exchanging electrical power in the manner contemplated herein, such as by including more than one inputs and/or more than one outputs for electrical power. The EVs 12, 14, 16 may include at least one camera 38 mounted thereon, which may be configured for capturing images or videos of an external environment. The camera 38, for example, may be configured to capture images for use with an image processing system (not shown). The captured images may be processed to generate identifiers and/or other information for nearby EVs 12, 14, 16, such as to facilitate identifying the EVs 12, 14, 16 interconnected for the tandem EV charging according to license plates 40 attached thereto.

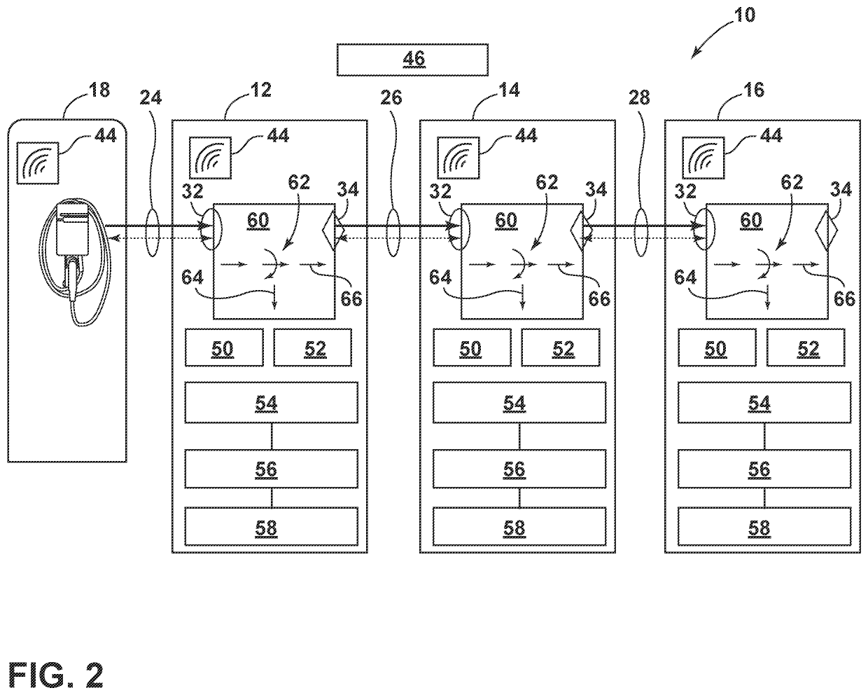

FIG. 2 illustrates a schematic diagram of the system 10 in accordance with one non-limiting aspect of the present disclosure. The charging station 18 and/or the EVs 12, 14, 16 may include a control module, a smart meter, a smart meter EV plug, and/or other type of device 44 operable for monitoring and/or controlling tandem charging related activities. The control modules 44 may optionally include wireless communication capabilities suitable for communicating with a back-office controller 46 and/or the other EVs 12, 14, 16. The control modules 44 and/or back office controller 46 may be configured to facilitate interactions with a mobile device, applications in the cloud, and the like (not shown), such as to facilitate mobile devices interacting with and/or otherwise directing activities of the system 10. The EVs 12, 14, 16 may include a power electronics unit or onboard charging module (OBCM) 50 and/or a software controller 52 to facilitate supplying electric power to and receiving electrical power from a battery or other rechargeable energy storage system (RESS) 54 onboard the EV. The EVs 12, 14, 16 may include an electric drivetrain 56 configured for electrically supplying electrical power to and receiving electrical power from an electric motor 58. The electric motor may be configured for propelling the EV using electrical power provided from the battery, such as by generating rotational force to a plurality of wheels (see FIG. 1). The electric motor 58 may be similarly operable in a regenerative manner to provide electrical power back to the battery.

A switch controller 60 may be included onboard the EVs 12, 14, 16 to facilitate the tandem EV charging contemplated herein. The switch controllers 60 may optionally be included as part of the charging receptacles 30. The switch controllers 60 may be operable in response to instructions received from the control module 44, the back office controller 46, and/or other devices onboard the EVs 12, 14, 16 or otherwise in communication therewith, e.g., a mobile device or application, to selectively actuate a charging switch. The switch controllers 60 may be operable with a charging switch 62 to control the charging switch between a battery position 64 and a bypass position 66. The battery position 64 may correspond with electrical power received at the input interface 32 being directed towards the battery 54. The bypass position 66 may correspond with electrical power received at the input interface 32 being directed towards the output interface 34, such as for transmission to a downstream connected one of the EVs 12, 14, 16. The charging switch 62 is shown to be operable between the battery position 64 and the bypass position 66 for non-limiting purposes as the present disclosure fully contemplates other configurations for the battery switch 62, including additional switches, circuits, etc. capable of metering and/or proportionally directing electrical power received at the input interface 32 simultaneously to both the battery 54 and the output interface 34, or additional interfaces in the event the receptacles 30 include additional interfaces.

The cables 24, 26, 28 used to interconnect the EVs 12, 14, 16 may be configured to provide a power connection for exchanging electrical power while also supporting control pilot, proximity, and ground connections. The electrical power is predominantly described with respect to flowing unidirectionally in a downstream direction from the charging station 18 sequentially or one-by-one to each of the EVs 12, 14, 16 connected in series. This is done for non-limiting purposes as the present disclosure fully contemplates non-sequential charging, parallel charging, and/or bi-directionally exchanging the electrical power, such as to facilitate one or more the EVs 12, 14, 16 providing electrical power upstream to another EV 12, 14, 16 and/or the charging station 18. The capability to provide electrical power upstream may be beneficial in enabling one or more the EVs 12, 14, 16 to facilitate charging one of the or more of the upstream connected EVs 12, 14, 16 in the event the charging thereof fails to complete on schedule and/or to provide electrical power to the grid 20, e.g., a grid 20 utility may pay for the extra electrical power and/or the grid 20 may be associated with a home or other entity such that the extra electrical power may be beneficial during a power outage or during peak usage periods to avoid enhanced utility fees.

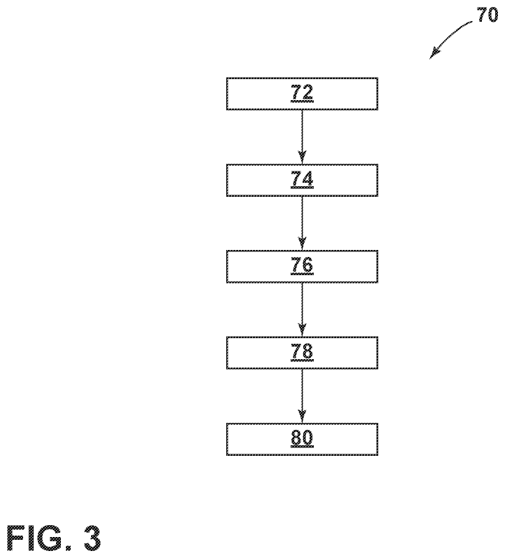

FIG. 3 illustrates a flowchart 70 of a method for tandem EV charging in accordance with one non-limiting aspect of the present of disclosure the method. The method may be supported and/or executed according to a plurality of non-transitory instructions stored wholly or partially on a plurality of computer-readable storage mediums, which when executed by a corresponding one or more processors, may be operable for directing the tandem charge and related activities described herein. The method is predominantly described with respect to tandem charging of the three EVs 12, 14, 16 connected in series according to the illustration of FIG. 1. This is done for non-limiting purposes as the present disclosure fully contemplates the method supporting tandem charging for more or less EVs 12, 14, 16, including EVs 12, 14, 16 interconnect with each other according to other methodologies, e.g., the EVs 12, 14, 16 may be interconnected with each other in series and/or parallel. The method is additionally described with respect to the charging station 18 including one charging cable, however, the method may be additionally used to support tandem charging for charging stations 18 having multiple charging cables and/or multiple access points for exchanging electrical power with EVs 12, 14, 16.

Block 72 relates to a detection process for determining the plurality of EVs 12, 14, 16 requesting charging via the charging station 18. The detection process may include communications between the charging station 18, the EVs 12, 14, 16, the back office and/or mobile devices, etc. The detection process may be an ongoing process whereby newly arriving EVs 12, 14, 16 may request access to the charging station 18, and/or departing EVs 12, 14, 16 may be removed from a pool of EVs 12, 14, 16 requesting charging at a particular point in time. The detection process may be facilitated with the camera included onboard the EVs 12, 14, 16. The detection process, for example, may include an image processing process whereby the EVs 12, 14, 16 may be configured for using the camera 38 to capture an image of the EVs 12, 14, 16 in proximity thereto and/or electrically connected thereto via one of the charging cables. The captured image may be processed to determine an identifier of the corresponding EV, such as by determining a sequence of characters comprising a license plate or other media attached thereto. The identifier may be shared with the back office 46 for cross referencing, lookup, or other research whereby an operator, an entity, etc. associated with the corresponding EV 12, 14, 16 may be determined.

Block 74 relates to a parameters process for determining charging parameters of the EVs 12, 14, 16 requesting charging as well as charging parameters for the charging station 18. The charging parameters for the EVs 12, 14, 16 may relate to a parking time, a charging speed, and statutory charging level. The parking time may be selected by the operators of each EV 12, 14, 16 to represent a duration or a length of time the EV may be expected to be parked near the charging station 18 and/or connected electrically connected to another one of the EVs 12, 14, 16. The charging speed may correspond with a rate at which the corresponding EV 12, 14, 16 may be charged, which may be specified according to amperes and/or kilowatts per hour. The charging level may represent a desired amount of battery charge for the corresponding EV 12, 14, 16, which may be specified according to state of charge (SOC) or the like. The EV charging parameters may also include information or requirements for other EVs 12, 14, 16 to connect thereto, such as instructions for requesting access to the charging receptacle 30, connection fees for connecting thereto, etc. The charging station 18 charging parameters may relate to capabilities of the charging station 18 to provide electrical power for meeting the charging demands of the EVs 12, 14, 16. The charging station 18 charging parameters may also include pecuniary charges, connection fees, or other requirements or details for receiving electrical power therefrom and/or provide electrical power to the EVs 12, 14, 16.

Block 76 relates to a scheduling process for scheduling charging of the EVs 12, 14, 16. The scheduling process may include assessing the charging parameters for the EVs 12, 14, 16 and the charging station 18 to determine a charging sequence for the tandem charging. A wide variety of computations may be employed to specify the distribution of electrical power between the charging station 18 and the EVs 12, 14, 16 depending how each are interconnected, e.g., different sequences may be required depending on whether the EVs 12, 14, 16 are connected in series and/or parallel. The scheduling process may determine the charging sequence to define when and/or how each of the EVs 12, 14, 16 may be charged. The charging sequence may factor or weight the charging parameters to prioritize or order the charging sequence, such as according to a quality of service (QoS), a duration each EV 12, 14, 16 is expected to be interconnected or parked near the charging station 18, a length of time expected to be consumed in charging each EV, etc. The charging sequence may specify an order for interconnecting the EVs 12, 14, 16 with each other in the event the charging cables may be movable between the EVs 12, 14, 16. The charging process charging sequence, alternatively, rather than dictating how the duties are to be interconnected, may include an analysis to determine the current interconnection of the EVs 12, 14, 16, e.g., the EVs 12, 14, 16 may be interconnected with each other in an ad hoc manner or a first come first serve basis whereby later arriving EVs 12, 14, 16 may be electrically connected to previously arrived EVs 12, 14, 16 such that the interconnection thereof may be dictated according to actions of the operators.

Block 78 relates to a charging process for distributing electrical power between the EVs 12, 14, 16 and/or the charging station 18. The charging process may correspond with the charging station 18 distributing electrical power to one or more of the EVs 12, 14, 16 and the EVs 12, 14, 16 thereafter distributing the electrical power to additional EVs 12, 14, 16 according to the charging sequence. The charging process may include the charging station 18, the back-office controller 46, the EVs 12, 14, 16, etc. correspondingly controlling the switch controllers 60 onboard each EV 12, 14, 16 selectively between the battery and bypass positions 64, 66 depending on whether the corresponding EV 12, 14, 16 is to direct electrical power received thereat to its battery 54 or a downstream-connected one of the EVs 12, 14, 16. The charging process may similarly include related control of the switch controllers 60 in the event the charging sequence may be used for bi-directionally exchanging electrical power, such as when utilizing the EVs 12, 14, 16 to provide electrical power to another EV and/or the grid 20 via the charging station 18. The charging process may be adapted as new EVs 12, 14, 16 arrived for charging, charged EVs 12, 14, 16 depart, or EVs 12, 14, 16 expected to remain connected become disconnected, such as when the parking time specified changes.

Block 80 relates to a billing process for billing participants to the tandem EV charging. The billing process may include the back-office controller 46 or other entity described herein tabulating an amount of electrical power consumed by each of the EVs 12, 14, 16, connection fees for connecting to the charging station 18 and/or the other EVs 12, 14, 16, charging fees for the electrical grid 20, prioritization fees paid by the EVs 12, 14, 16 to preempt other EVs 12, 14, 16 or obtain higher priority, etc. The billing process may include determining a station amount of power and/or a vehicle amount of power consumed by each of the EVs 12, 14, 16. The station amount of power may correspond with an amount of power a particular EV 12, 14, 16 consumed from the charging station 18. The vehicle amount of power may correspond with an amount of power a particular EV 12, 14, 16 consumed from one or more of the other EVs 12, 14, 16. The billing process may be configured for tabulating pecuniary charges that each of the EVs 12, 14, 16 are to pay in recompense for the tandem charging thereof. The charging process may include cross-referencing the identifier determined for each EVs 12, 14, 16 as part of the detection process, such as to facilitate the back-office controller 46 or other entity automatically charging a credit card or bank account of the operator and/or generating a billing invoice to be paid by each participant.

As supported above, the present disclosure may enable a vehicle to be effectively used as a cable to another vehicle. A primary vehicle connected to the electric power grid may be configured to bypass electricity to a next vehicle without affecting the battery of the primary vehicle by using a switch controller module. A smart meter EV plug may be configured to connect to the cloud for allowing a normal home EV plug to enable or disable EV charging based on a user account authentication process, and to calculate the amount of power withdrawn from the grid to the EV plug for charging one or more smart EVs or a normal EV. Two or more smart EVs may be connected to an EV plug or smart meter-based EV plug to coordinate and execute an EV charging activity based on an EV charging scheduling protocol or sequence. The scheduling protocol may include considering the expected driving range, parking schedule, charging rate, and power demand for each of the connected vehicles without overloading the power grid. The present disclosure may enable smart vehicle owners to maximize the utilization of their power resources with the convenience of not having to move their vehicle, which may reduce the cost of installing extensive charging stations for homes, residential buildings, and business owners.

One aspect of the present disclosure relates to a system including a primary vehicle connected to an electric EV charger plug that may be configured to bypass electricity and its charging control signals to a next vehicle. The system may include a smart power meter connected to a normal EV charger plug or a power grid to bypass or disable the current flow based on an EV charge request. In the event two or more smart EVs may be connected to one EV charger or smart meter-based EV charger, the system may be configured to coordinate and execute an EV charging activity. The system may be configured with a scheduling and multi-agent negotiation algorithm to coordinate the power grid utilization based on the expected driving range, parking schedule, charging rate, and power demand for each of the connected vehicles without overloading the power grid. A switch controller may be included onboard the vehicle to control whether to charge a smart EV or bypass the electric current to a next EV, such as based on information provided by communicating with a primary smart EV module through a wireless connection. The system may include a smart EV that includes one or more input EV charging ports and one or more output EV charging ports. The ports may be wireless pads/or wired connections with different charging configuration such as SAE, L1, L2, or L3 DC fast charging. EPTO (Electrically Propelled Trailer Operation) connections utilized with added bypass functionality, and/or wireless pads under the vehicles may allow a single charge port to be used for vehicle transfer, wireless pads may be built into vehicles.

One non-limiting aspect of the present disclosure relates to the system employing various communication mechanisms. The communications mechanism may include V2V wireless communications that allows Primary and Secondary smart EVs to exchange EV charging account and charging request information. The communications mechanism may include secondary EV owner's smartphone to a primary smart EV (PSEV), or straight to charger using a companion application and local wireless or wired connection or internet connection. The communications mechanism may include a secondary smart EV (SSEV) being connected to exchange information related to EV charging account and charging request information, which may be useful in allowing SSEV to act on-behalf of the EV charger owner or PSEV without the need of PSEV to exist in the charging chain. An on-demand cloud-service or dial number-based (for example: OnStar) may be employed as an intermediary from a secondary vehicle to the charger SSEV or PSEV. A charging network may be used to allow a secondary vehicle to connect to the nearest subscribed vehicle and receive EV charging from the nearest charging station.

One non-limiting aspect of the present disclosure relates to the system employing various payment methods. The payment methods may include a SEV being connected to the cloud to confirm their registered account info (license plate number/driver's license/charging insurance policy). This may be used to request a charge/process payment and synchronize system update. In addition, monitor and announce the charging status of the secondary SEV. The payment methods may include surround-view camera-based system that enables recognizing a license plate of the secondary EV when parked to charge so that the system provides a seamless charging experience and proof-of-purchase. A PSEV may be connected to the cloud to search for the secondary vehicle using their license plate number and/or to request a charge/process payment with the secondary vehicle and synchronize system update. The payment methods may include SSEV using an included camera to verify info of PSEV and process charging info, similarly to the secondary EV (if PSEV is not available) and/or an RFID/NFC/tag reader (tap) to unlock the charger and enable the secondary vehicle.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions), unless otherwise indicated expressly or clearly in view of the context, including the appended claims, are to be understood as being modified in all instances by the term “about” whether or not “about” actually appears before the numerical value. A component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims. Although several modes for carrying out the many aspects of the present teachings have been described in detail, those familiar with the art to which these teachings relate will recognize various alternative aspects for practicing the present teachings that are within the scope of the appended claims. It is intended that all matter contained in the above description or shown in the accompanying drawings shall be interpreted as illustrative and exemplary of the entire range of alternative embodiments that an ordinarily skilled artisan would recognize as implied by, structurally and/or functionally equivalent to, or otherwise rendered obvious based upon the included content, and not as limited solely to those explicitly depicted and/or described embodiments.

What is claimed is:

1. A method for tandem electric vehicle (EV) charging, comprising:
determining a primary EV electrically connected to a charging station via a vehicle-to-station (V2S) connection, the charging station configured for charging the primary EV with electrical power provided from an electrical grid;
determining a secondary EV connected to the primary EV via a vehicle-to-vehicle (V2V) connection, the secondary EV requesting to be charged with electrical power transferred from the primary EV via the V2V connection;
determining a secondary EV billing account associated with an operator of the second EV; and
authorizing a pecuniary charge to the secondary EV billing account in recompense for a secondary transference of electrical power to the secondary EV via the V2V connection.

2. The method according to claim 1, further comprising:
determining the pecuniary charge based at least in part on a station amount of electrical power included as at least part of the secondary transference, the station amount corresponding with electrical power provided from the charging station for the secondary transference.

3. The method according to claim 1, further comprising:
determining the pecuniary charge based at least in part on a vehicle amount of electrical power included as at least part of the secondary transference, the vehicle amount corresponding with electrical power provided from a battery of the primary EV for the secondary transference.

4. The method according to claim 1, further comprising:
determining the pecuniary charge based at least in part on a connection fee for the V2V connection.

5. The method according to claim 1, further comprising:
instructing the primary EV to perform a bypass operation as part of the secondary transference, the bypass operation bypassing electrical power received at the primary EV via the V2S connection to the secondary EV via the V2V connection.

6. The method according to claim 5, further comprising:
instructing the primary EV as part of the bypass operation to control a charging switch from a battery position to a bypass position, the battery position directing electrical power received via the V2S connection to a battery of the primary EV, the bypass position directing electrical power received via the V2S connection to the V2V connection.

7. The method according to claim 1, further comprising:
performing a scheduling process to schedule the secondary transference based on a parking time, a charging speed, and a charging level determined for each of the primary and secondary EVs.

8. The method according to claim 7, further comprising:
the scheduling process scheduling the secondary transference to occur after the charging level of the primary EV has been met via a primary transference of electrical power from the charging station to the primary EV via the V2S connection.

9. The method according to claim 8, further comprising:
determining a tertiary EV connected to the secondary EV via another V2V connection; and
the scheduling process scheduling a sequential charging of the EVs according to the charging parameters, the sequential charging corresponding with electrical power originating from the charging station being used to selectively charge no more than one of the EVs at the same time.

10. The method according to claim 1, further comprising:
processing an image captured for the secondary EV to determine a license plate attached to the secondary EV;
processing the license plate to determine an identifier associated with the operator of the secondary EV; and
determining the secondary EV billing account based on the identifier.

11. A method for tandem electric vehicle (EV) charging, comprising:
determining a plurality of EVs requesting to be charged with electrical power available from a charging station, the plurality of EVs including:
a primary EV electrically connected to the charging station via a vehicle-to-station (V2S) connection, the primary EV requesting to be charged with electrical power transferred from the charging station via the V2S connection;
a secondary EV connected to the primary EV via a primary vehicle-to-vehicle (V2V) connection, the secondary EV requesting to be charged with electrical power from the primary EV via the primary V2V connection;
determining a tertiary EV connected to the secondary EV via a secondary vehicle-to-vehicle (V2V) connection, the tertiary EV requesting to be charged with electrical power transferred from the secondary EV via the secondary V2V connection;
determining charging parameters for the EVs; and
scheduling a sequential charging of the EVs according to the charging parameters, the sequential charging corresponding with electrical power originating from the charging station being used to selectively charge no more than one of the EVs at the same time.

12. The method according to claim 11, further comprising:
controlling a charging switch onboard each of the EVs to a bypass position when another EV downstream thereof is scheduled for charging, the bypass position bypassing electrical power originating from the charging station to a downstream connected one of the EVs.

13. The method according to claim 11, further comprising:
the charging parameters including a parking time, a charging rate, and a charging level, the parking time representing a time the corresponding EV is scheduled to be connected to another one of the EVs, the charging rate representing amperes or kilowatt rate available for charging the corresponding EV, the charging level representing a desired amount of battery charge for the corresponding EV.

14. The method according to claim 11, further comprising:
authorizing a pecuniary charge to operators associated with each of the EVs in recompense for the electrical power consumed in the charging thereof.

15. The method according to claim 14, further comprising:
identifying the operators associated with each of the EVs according to an image recognition process performed on a license plate image captured therefrom.

16. A controller for tandem electric vehicle (EV) charging, configured for:
determining a plurality of EVs requesting to be charged with electrical power available from a charging station;
determining charging parameters for the EVs; and
scheduling a sequential charging of the EVs according to the charging parameters, the sequential charging corresponding with electrical power originating from the charging station being bypassed from EV to EV with no more than one of the EVs charging at the same time.

17. The controller according to claim 16, further configured for:
authorizing a pecuniary charge to operators associated with each of the EVs in recompense for the electrical power consumed in the charging thereof.

18. The controller according to claim 17, further configured for:
identifying the operators associated with each of the EVs according to an image recognition process performed on a license plate image captured therefrom.

19. The controller according to claim 18, further configured for:
controlling a charging switch onboard each of the EVs to a bypass position when another EV downstream thereof is scheduled for charging, the bypass position bypassing electrical power originating from the charging station to a downstream connected one of the EVs.

20. The controller according to claim 16, further configured for:
controlling the charging switch onboard each of the EVs to a battery position when scheduled for charging, the battery position directing electrical power originating from the charging station to a battery of the corresponding EV.
